(19) United States
(12) Patent Application Publication
(10) Pub. No.: US 2011/0098986 A1
(43) Pub. Date: Apr. 28, 2011

(54) METHOD TO GENERATE AIRPORT OBSTRUCTION CHARTS BASED ON A DATA FUSION BETWEEN INTERFEROMETRIC DATA USING SYNTHETIC APERTURE RADARS POSITIONED IN SPACEBORNE PLATFORMS AND OTHER TYPES OF DATA ACQUIRED BY REMOTE SENSORS

(76) Inventors: Marco Alexandre FERNANDES RODRIGUES, Moita (PT); Henrique José Monteiro Oliveira, Queluz (PT)

(21) Appl. No.: 12/910,455

(22) Filed: Oct. 22, 2010

(30) Foreign Application Priority Data
Oct. 23, 2009 (PT) 104798

(51) Int. Cl. G06F 17/50

(52) U.S. Cl. 703/1

(57) ABSTRACT

A method to generate Airport Obstruction Charts is based on a fusion between interferometric data acquired by Synthetic Aperture Radars positioned in spaceborne platforms and other types of data acquired by remote sensors. It is characterized by the following stages; —Conversion of pre-existent analog data of the surveyed areas to digital format: —Vectorization of the data; —Data analysis already in digital format; —Generation of Digital Surface Model (MDS, being the input data structure to be used by the Land Change Detection Algorithm, in raster format; —Comparison between the initial Digital Surface Model and the new data acquired in a later epoch; —Comparison between the base Digital Surface Model (MDS) and the altimetric data structure derived from interferometric data obtained from the Synthetic Aperture Radars positioned in spaceborne platforms; —Registration and georeferencing of the Digital Surface Model (MDS); —Cut the image to ensure that all the surveyed area is correctly identified; —Resampling of the raster models to be compared with those obtained between the initial and latter epochs, in order to present the same number of pixels either in line or column, representing the same surveyed area; —Detection of land changes in order to compare the elevations in both digital surface models (MDS) obtained from different epochs, to produce a third raster model; —Overlay between the raster images of the objects considered as obstructions and the Airport Obstruction Chart in vector format; —New obstructions validation; —and dissemination of the new Airport Obstruction Charts to the relevant authorities.

### BACKGROUND OF THE INVENTION

The need of accurate tridimensional geographic information data by the authorities for the management of aeronautical infrastructures and related to the standard Aerodromes coverage Areas, stated in Aeronautical International Standards and Recommended Practices by the International Civil Aviation Organization (ICAO), has been one of the major requirements of the aeronautical safety management community.

The current proposal addresses the safety issue related with the obstructions (notably its locations and heights), positioned in the surroundings of the aeronautical infrastructures (airports and other aerodromes), which need to be declared in Airport Obstruction Charts (AOC) and Precision Approach Terrain Charts (PATC), fulfilling the requirements stated in ICAO's Annex 4, Annex 14 and Annex 15.

These charts are managed by civil aviation authorities or the authority for the management of Aerodromes. Its designing and technical specifications are regulated worldwide by ICAO and in Portugal by INAC (the Portuguese civil aviation authority).

Nowadays, a fast update procedure of airport obstruction charts is required due to the increase in safety restrictions related to the aviation transport market. Most of the studies related to obstacles are conducted along several years apart, between the moment of the production of a Precision Approach Terrain Charts (PATC) or Airport Obstruction Charts (AOC) and the time of its update. Usually a one year window or more is obtained between the two previous moments in time, even using the actual state-of-the-art technology, the Airborne Laser-Scanning and Light Detection and Ranging (ALS/LiDAR), regarding a regular obstruction data structure acquired over a small surveyed area. This makes data often becoming obsolete when the data structure is finished, and also without fulfilling the deadlines stated in ICAO's Annex 15, Chapter 10, paragraph 10.6, regarding the availability of terrain and obstacle data for large and very large surveyed areas.

A trade-off analysis between airborne LiDAR, the state-of-the-art technology so far used in the scope of this type of application, and spaceborne Synthetic Aperture Radar platforms, shows that the flight altitude of the aircraft is obviously much lower than satellites, therefore, the data acquisition method of airborne LiDAR generally add several inconveniencies which are frequently or systematically associated to the data acquisition procedure:
Severe restrictions in airfield operations during LiDAR flights for data acquisition, generating highly dangerous operations due to low flight altitudes needed;
Huge delays in flight departs and arrivals procedures specially in high traffic airports also due to the necessary suspension of the airfield operations;
In some cases the LiDAR data acquisition is restricted to daytime flight.

The time spent to process airborne LiDAR data is huge (generally more than six months for a very small, to almost two years or more for a medium to large surveyed standard areas), requiring the analysis of billions of points even for small coverage areas and correcting all of them from displacements errors, because it is a point based application in a tridimensional environment, being necessary to do a spatial rectification procedure between all the acquired points, regarding errors associated to the flight path of the airplane, and also to execute another rectification procedure now between different strips of points acquired during different epochs for the same monitored area. Although the processing of acquiring airborne LiDAR data is made by using advanced digital equipment, it is done almost point by point and it is slow due to the processing of a huge amount of data, highlighting another drawback related with the use of this type of remote sensor, i.e. it leads to high costs of data production. In Saksono T. et al., “The future of maps of Indonesia: “Benefit of leading edge radar interferometry technology”, in Map Asia 2003, Technology Trends, 2003, limitations related to computational efforts made are referred, implying the processing being made in Oytawa (EUA) for data coming from a project in Indonesia.

Data acquired from spaceborne platforms does not require specialized hardware for the technical processing, since its core domain is based on a grid structure (raster model) instead of a point based one. So, the intention behind the use of a raster based model is to guarantee that for each pixel, which represents a small covered area, we have its digital number (which is its height in the current focus domain) equal to the highest object in that pixel area. It is stated in the scientific community that the survey of large or very large coverage areas, for example the entire territory of a State, is unfeasible when airborne LiDAR technology is used, while the spaceborne sensors represent an adequate alternative and there are also a low cost solution, i.e., spaceborne remote sensors present a low cost solution regarding the data acquisition procedure.

The ALS/LiDAR data acquisition systems are near vertical remote sensing units. The spaceborne Synthetic Aperture Radar platforms are side-scan systems, presenting themselves as an advantage for this specific type of application—obstacle data for Aeronautical purpose. As an example, any small area objects with great height development, like a 30 meters height antenna, represented in a LiDAR derived DSM, reveal a very small detected area, while a much larger one is obtained for the same scanned object when a side-scan RADAR system is in use, due to its slant range sensing characteristic.

Additionally, the bandwidth of the energy used in the LiDAR remote sensing technology is usually small (usually Near Infra-Red), which is severely affected by atmospherical conditions, inducing undetectable errors in the height data, in the opposite of Spaceborne SAR technology since it can operate in all weather conditions, whether its day or night time.

The accuracy of LiDAR data varies along the studied area due to frequently changes of flight altitude of the aircraft. Moreover, the inertial GPS systems attached to the aircrafts used for carrying the hardware of LiDAR systems have some difficulty to account accurately for errors originated by aircraft movements along its longitudinal axis (usually referred as roll induced errors), when comparing to those derived from Space Vehicles. Adding the variability of the returned signals, due to humidity and small particles in suspension in the atmosphere (aerosols), the airborne LiDAR system accuracy is described in terms of radiometric accuracy, instead of true altitude accuracy.

Some methods to generate airport obstruction charts are known. Thus:

In Garrity C., “Digital Cartographic Production Using Airborne Interferometric Synthetic Aperture Radar (IFSAR), North Slopem Alaska, 2005 e Saksono T. et al., “The future of maps of Indonesia: “Benefit of leading edge radar interferometry technology”, in Map Asia 2003, Technology Trends, 2003, the principles of the SAR technique are described, based on the description made by the scientific community since the eighties, where a work made by INTERMAP is presented regarding the implementation of a service to acquire data to produce a Digital Surface Model (MDS) and a Digital Terrain Model (DTM), but with difficult application to aeronautical purposes. And if the service was implemented in 2003, in 2010 the temporal resolution of the data obtained using the technique described in the paper is not efficient in terms of the cost/benefit ratio, due to the fact that none data update procedure was executed along one year or less at reasonable costs. In Garrity C., “Digital Cartographic Production Using Airborne Interferometric Synthetic Aperture Radar (IFSAR)”, North Slopem Alaska, 2005, the data acquisition recurring to SAR sensors is mentioned, revealing also a good spatial resolution, but it will be practically unfeasible to collect information for the entire territory of a state during a reasonable temporal window if the acquired data will be used for aeronautical purposes, because the paper refers the use of Synthetic Aperture Radars positioned in airborne platforms (IFSAR Airborne Interferometric Synthetic Aperture Radar). Moreover, the approach presented in the paper is not adequate for application to aeronautical purposes, since the numerical requirements required by ICAO's Annex 15, Chapter 10, are not fulfilled, and also the temporal resolution of the acquired data is not adequate, since data update procedure is schedule only for 5 years, which is difficult to compare with the surveys provided by some already existents spaceborne SAR sensors like TERRASAR-X or RADARSAT, or even those future systems like the SENTINEL. Meanwhile, a short reference is made in the same paper to the use of Lansat 7 and AVHRR data, but for the case of the proposed invention the main goal is to detect altimetric changes related to the existence of new obstacles, instead of building a Digital Surface Model (DSM) of the entire area being monitored.

In Alves et al., “Fundamentos do processamento interferométrico de dados de radar de abertura sinética”, in Anais XIV Simpósio Brasileiro de Sensoriamento Remoto, Natal, Brasil, INPE, p. 7227-7234, 2009 the mathematical principles of Synthetic Aperture Radars are described and although the use in the field of deformations is mentioned, the main goal here is not related with the technique used to process the images coming from Synthetic Aperture Radars since those techniques already exist, but only the processing of the data captured by Synthetic Aperture Radars positioned in spaceborne platforms and its fusion with other type of data remotely acquired is under the scope of the proposed invention, capable of producing and updating Airport Obstruction Charts in a short period of time, which is not possible to overcome using the techniques presented in all the previous references, based on the use of Synthetic Aperture Radars positioned in airborne sensors.

With the proposed invention, it is not necessary to stop or suspend the airfield operations, which is considered as one of the major advantages, apart from others, when compared to the use of Airborne Laser-Scanning and Light Detection and Ranging (ALS/LiDAR) sensors, being the current state-of-the-art technology. The implementation of an automatic process to analyze georeferenced data in a Geographic Information System (GIS) environment to update and supply the AOC's efficiently in the second stage is also another technical advantage of the proposed invention. At this stage, stereoscopy imagery from PRISM-ALOS (Panchromatic Remote-sensing Instrument for Stereo Mapping-Advanced Land Observing Satellite) or SPOT-5 (multi-pass) can also be integrated together with the DSM's generated using spaceborne SAR Interferometric, for confidence level enhancement of the Obstruction Objects declared in the resulting charts.

Besides the issues related to data capturing procedures and the production of Airport Obstruction Charts, the tool created for managing the data structure developed under the scope of this invention will be able to assist managing personnel at any airport, in other activities, notably: planning, zoning, and even licensing of man-made objects, in which all the mentioned activities are based only on the ICAO's Annexes 4, 14 and 15.

Space-borne sensors trajectories are far more “stable” than an aircraft flight path due to its distance to the ground, and its data acquisition can be regarded almost as instantaneous for a very extensive area, normally comprising the whole area analyzed for any given airport in one single image or the entire territory of a State as stated in ICAO's Annex 15 Chapter 10, —eTOD, Electronic Terrain and Obstacle Data. This fact envisages that any errors presented into the data (image) are homogeneously distributed at each slant range line scan, representing a great advantage when image geometric correction procedures are executed. As for LiDAR, most of the times several “strips” or “clouds” of points are acquired in different days during weeks for the entire surveyed area, and this fact can introduce severe geometric errors between those sets of points, being very difficult to account for.

All of the previous limitations regarding the actual state-of-the-art technology used under the scope of the proposed invention, enhances the advantages of the proposed process, which is based on the use of spaceborne Synthetic Aperture Radar interferometry technology to acquire terrain and obstacle data for aeronautical purposes in strictly accordance with ICAO's Annex 4, Annex 14, Annex 15, i.e. the development of a low cost procedure and a fast achievement of an obstruction data structure.

With the same amount of money used to update an AOC with LiDAR once a year, a frequently more reliable update of tridimensional georeferenced information data in standard surveyed areas around Aerodromes can be made with the invention, even almost on-demand, several times a year, or according to the periodicity decided by the managing personnel of any aerodrome infrastructure, without actually affecting the airfield operations. If airfield operations need to be stopped during the data acquisition process for a given amount of time, then high costs will be indirectly associated with the use of the current state-of-the art technology, i.e. airborne LiDAR remote sensing systems.

Another innovative aspect that clashes unquestionably when comparing the proposed invention with the current state-of-the-art technology is the fact that a weekly update of the obstacle data can be made if necessary, which is a topic that should overcome the vertical accuracy issue for the most demanding surveyed areas, in terms of terrain obstacle data numerical requirements. ICAO recommends that obstacle data should declare “permanent” or “temporary” obstacles within the given surrounding areas of aerodromes (the most demanding ones as previously referred) and for example, a crane placed in a construction site for a single day in the surroundings of an airport, it might be declared in an Airport Obstruction Chart for years, until another LiDAR campaign for updating data is scheduled. The proposed invention has a much better connection between reality and the declared obstacles due to its higher update rate, because the temporal resolution of the acquired data is enhanced when a spaceborne SAR Interferometry remote sensing system is used.

### SUMMARY OF THE INVENTION

The invention refers an innovative process based on the existence of a Digital Surface Model (DSM)—in terms of its altimetric precision and spatial resolution—corresponding to the first reflective surface, i.e. top of the buildings, top of telecommunications antennas, top of the bridges, etc., build using spaceborne Synthetic Aperture Radar Interferometry technology, in a short period of time (less than six months) for a very broad coverage area (ex: entire territory of a State), and its fusion with other types of data acquired by remote sensors, notably high resolution optical images, multi-spectral and hiper-spectral images. In the first stage of the method, the conversion from analog to digital format of any pre-existent data that stays inside the monitored areas is made, in accordance with the WGS84 Implementation Manual (WGS84) from EUROCONTROL. In the second stage, a raster model is build and compared with the new Digital Surface Model (DSM), obtained by interferometric processing of remote data acquired by Synthetic Aperture Radars positioned in spaceborne platforms, identifying new obstructions and declaring them in an update Airport Obstruction Chart, after applying a Land Change Detection protocol. The latter DSMs obtained after the initial DSM are build using a data fusion between the data obtained from interferometric processing of Synthetic Aperture Radars positioned in spaceborne platforms and other types of data that will be considered useful for the purpose. After building this precise Digital Surface Model (DSM), it will be integrated into an Automated Land Change Detection protocol to update and broadcast these AOC's, in digital format, in a short period of time (a month or less as required). This process will also permit the collection and constant update of sets of electronic terrain and obstacle data covering the 4 territorial areas as specified in ICAO's Annex 15, Chapter 10, which are necessary to accommodate air navigation cockpit or ground based systems or functions.

This innovative idea is based on the use of spaceborne Synthetic Aperture Radar Interferometry using sensors positioned in spaceborne platforms, instead on the use of Airborne Laser-Scanning/and Light Detection and Ranging sensors ALS/LiDAR, the latter being known as the actual state-of-the-art technology used in this type of application, as the technique for terrain and obstacle data acquisition known as <<obstructions>> according to ICAO's Aeronautical International Standards and Recommended Practices. The set of acquired terrain and obstacle data that is considered as obstructions, need to be declared in AOC's, in a strictly compliance with the requirements stated in ICAO's Annex 15, Chapter 10, electronic Terrain and Obstacle Data. The monitoring of large areas is considered unfeasible when trying to execute the surveys in a short period of time (less than six months) using the actual state-of-the-art technology (ex: for Area 1, the entire territory of a State needs to be surveyed), taking into account the collection of all the required aeronautical information included in the same coverage area.

Thus, the proposed invention presents, shortly, the following advantages:
It reduces, sharply, the time spend to acquire terrain and obstacle data;
It reduces the production time of a new Airport Obstruction Chart (AOC);
It reduces the updating time of an existent Airport Obstruction Chart (AOC);
It avoids the suspension of the airfield operations during remote acquisition of terrain and obstacle data;
It fulfills the numerical requirements for terrain and obstacle data related with the surveying Areas 1 and 2, stated in ICAO's Annex 15, Chapter 10, (eTOD);
It enables the terrain and obstacle data acquisition under any atmospheric conditions;
It reduces the complexity of the Airport Obstruction Charts (AOC) producing chain/updating;
It enables the acquisition of data to be used for applications related to the air navigation, according to the listing given in ICAO's Annex 15, Chapter 10, paragraph 10.1.

### BRIEF DESCRIPTION OF THE DRAWINGS

This description is made regarding the drawings in attachment, which represent without any limitation:

FIG. 1, a diagram of the conversion of pre-existent data;

FIG. 2, a diagram of the land change detection;

FIG. 3, a, b, c, d and e showing typical raster models and the necessary overlaid process.

### DETAILED DESCRIPTION OF THE INVENTION

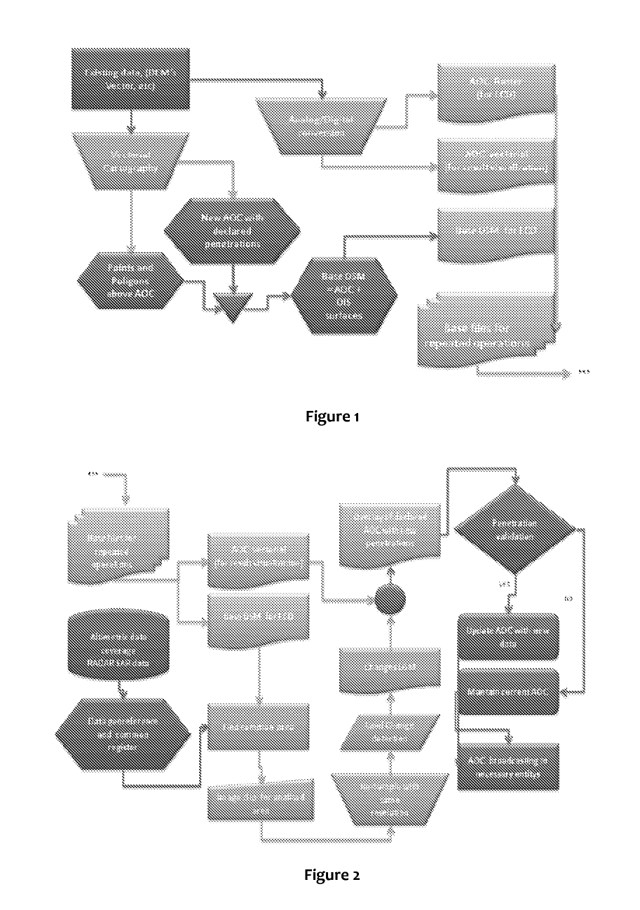

As can be seen in FIG. 1, the data in analog format are converted to digital format, by digitizing points, lines and polygons and assuring that any existing images are converted to raster format (example: orto-rectified imagery, among other types of images). However, the data elements that may already exist in digital format need to be analyzed, because they generally correspond to specific data acquired over a certain period of time, becoming necessary to build a global data structure associated with the area to be monitored. Either in the case of digitized analog data, or in the analysis of data already in digital format, all the combined information composes a Digital Surface Model (DSM) as the data structure to input in the Land Change Detection algorithm in raster format. All these data files are relate to the initial epoch of the Digital Surface Model (T₀) and are used for comparison with new data acquired in a new epoch (T₀₊₁ or the following epochs). Based on previous conversion process, a vector file is obtained (Vectorial Airport Obstruction Chart) only for overlaid purposes of the results, using the base Digital Surface Model (DSM) to detect land changes in Raster format.

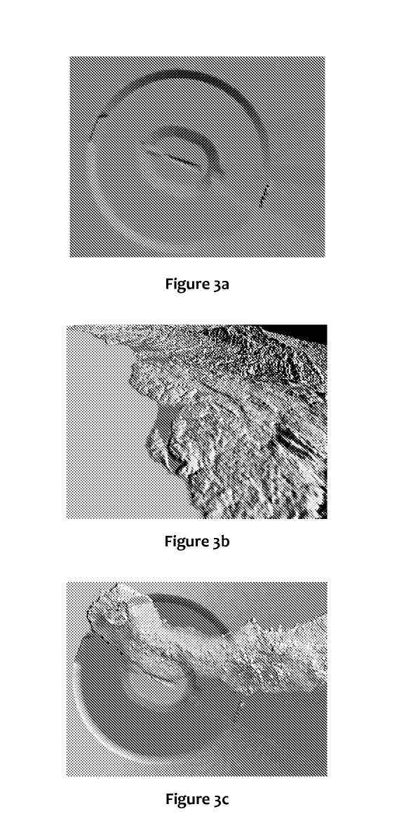

This base Digital Surface Model (DSM) is compared with a structure of altimetric information derived from Interferometric data collected by synthetic aperture radar sensors positioned in space borne platforms (see FIG. 2). Later, after co-registering and geo-referencing all the analyzed data properly, the images should be clipped in order to ensure that the entire area being monitored is correctly identified (image cropping for the area being monitored).

In general, the raster data acquired in epochs Tₒ and T₀₊₁ (or following epochs) may present a slight horizontal offset (at sub-pixel level) and different spatial resolutions. In order to obtain the best results when applying the Land Change Detection Protocol, it should be ensured that both raster models being compared must have same number of pixels in row and column, representing the same area being monitored (a step so called re-sampling).

After applying the re-sampling step, the Land Change Detection step is activated, comparing elevations (or altitudes) in both digital surface models (from different epochs). The result of the arithmetic difference between both models, within a certain threshold, will produce a third raster model, in which the digital number associated to each pixel of the model represents the absence of penetration, or the identification of a new penetration of the obstruction surface, as well its amount above the three-dimensional obstruction surface of the airport being analyzed. The raster image of the objects that are considered obstructions is subsequently overlaid with the Airport Obstruction Chart in vector format, as mentioned earlier.

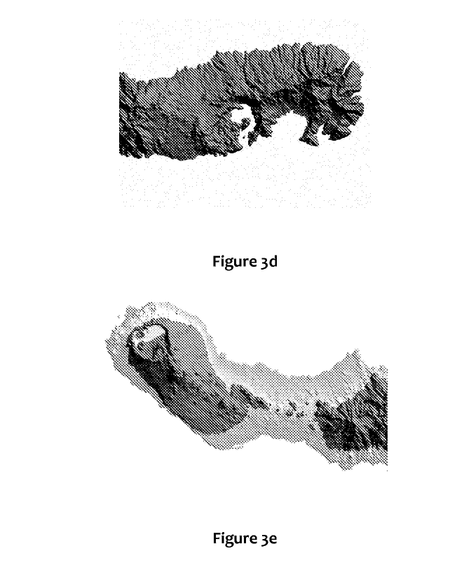

After this overlay, new obstructions are also validated. If they represent new obstructions between the T₀ and T₀₊₁ epochs (or following), this validation can even be obtained simply by a visual check (or confirmed through further data fusion techniques for comparison between the two seasons). For example, if there is a new penetration caused by a new building, this information must be updated and declared in the AOC. But if for any reason such occurrence does not correspond to a new obstruction, information referring to the pixels in focus must be maintained in the epoch T₀ and evaluated in order to understand why there was such indication of obstruction in the Land Change Detection Protocol. In order to identify obstructions (its locations and heights), an overlay procedure is applied to the following geo-referenced data:
A three-dimensional Surface built to the mandatory monitored areas, according to the existing information in the ICAO's, Annex 4, Annex 14, and Annex 15 and related to the aeronautical infrastructure (see example at the top of FIG. 3);
A three-dimensional Surface obtained by merging both DSMs (the previous and the new one) and other stereoscopic imagery like PRISM-ALOS (Panchromatic Remote-Sensing Instrument for Stereo Mapping-Advanced Land Observing Satellite) or SPOT-5 (multi-pass), if necessary.

Finally, with the new AOC data of the epoch T₀₊₁ fully validated all the obstruction data may be broadcasted to the necessary entities.

The expected experimental results are very close to the requirements presented in ICAO's 15 Annex, i.e. between meters and 3 meters in terms of vertical accuracy (probably closer to the lowest value, which is 3 meters, defined as the maximum vertical precision being achieved with this proposal, in compliance with the most demanding requirements presented in ICAO's Annex 15, Chapter 10-eTOD—for Area 2). A trade-off between the time required to perform a single data update operation (expected along a week) and the precision guaranteed by this process, will be one of the assumptions of the proposal. This implies a greater progress related to the security issues associated with airport operations (free from interruptions/suspensions and getting data from obstructions closer to the ground reality). Even if only 5 meters of vertical accuracy have been achieved, this proposal will also be an important advantage when compared with any current procedure, due to the increasing in safety of airport operations, since the database of obstructions declared in AOCs is updated in a very short period of time.

An improvement in quality of the Digital Surface Model (DSM) is obtained by interferometric process of Synthetic Aperture Radars positioned in space borne platforms, using the invention described earlier for aeronautical purposes. There are two distinct areas related to the data requirements of terrain and obstacles (in accordance with ICAO's Annexes 14 and 15), identified as Area 1 and Area 2 (geometrically characterized in ICAO's Annex 15). For Area 1, 30 meters of numeric vertical precision for obstacles is the numerical requirement. For the case of Area 2, 3 meters of numeric vertical precision for obstacles is the stated numerical requirement. The value of precision indicated for Area 2 presents itself as somehow ambitious, taking into account the well-known estimated accuracies achieved when using data collected by spaceborne SAR sensors. However, 3 meters of vertical accuracy is one of the objectives to be achieved by the invention, also respecting a confidence level of 90% of the obstacle data that penetrates the obstruction surfaces concerning Areas 1 and 2, for its appropriate identification on each of these areas, according to indications in ICAO's Annex 15.

For the case of the remaining areas listed in the ICAO's, Annex 15, notably Area 3 and Area 4, although the results of the invention do not attain the level of confidence required regarding the absolute vertical accuracy needed in accordance with ICAO's Annex 15, the invention can also be implemented for those areas, since an higher vertical relative precision (vertical millimeter precision) is obtained when data from spaceborne SAR sensors are analyzed along different sequential epochs.

1. Method to generate Airport Obstruction Charts based on a data fusion of Synthetic Aperture Radar positioned in spatial platforms with other data obtained by remote sensors, characterized by the following steps:
Conversion of pre-existing data from analogue to digital format, located inside the monitored areas;
Vectorization of the data;
Analysis of data already in digital format;
Building of Digital Surface Model (DSM) as the data structure to input in the algorithm to detect land changes, in raster format;
Comparison of digital surface model concerning initial epoch with new data acquired later in time;
Comparison of the base digital surface model (DSM) with the structure of altimetric information, derived from Interferometric data obtained by synthetic aperture radar sensors positioned in spaceborne platforms;
Co-registration and geo-referencing of the digital surface model (DSM);
Image cropping to ensure that the entire area to be monitored is properly identified;
Re-sampling of the raster models to be compare from the initial and subsequent epochs, so that they present the same number of pixels in row and column, representing the same monitored area;
Detection of land changes to compare elevations in both digital surface models (DSM) derived from different epochs, in order to produce a third matrix model;
Overlaying between the raster images of objects that are considered obstructions and the Airport Obstruction Chart;
Validation of new obstructions; and
Broadcasting of a new Airport Obstruction Chart to the competent authorities.

2. Method to generate Airport Obstruction Charts according to claim 1, characterized by the vectorization of data to be held point-to-point, per line and polygon, converting the existing images to raster format.

3. Method to generate Airport Obstruction Charts according to claim 1, characterized by the orto-rectification of the images.

4. Method to generate Airport Obstruction Charts according to claim 1, characterized by the third raster model being the result of the altimetric differences between previous models, where the digital number associated with each pixel of this third model represents the absence of penetration, or the identification of a new penetration in the obstruction surface, as well as its amount above the three-dimensional obstruction surface of an airport being analyzed.

5. Method to generate Airport Obstruction Charts according to claim 1, characterized by the validation of new obstructions between the initial (T₀) and later (T₀₊₁) epochs, being accomplished by visual verification or checking by other complementary data fusion techniques, for comparison between two epochs.

6. Method to generate Airport Obstruction according to claim 1, characterized by, identifying obstructions, their locations and heights obtained by an overlay procedure with the following geo-referenced data:
A three-dimensional Surface built according to the existing information in ICAO's, Annex 4, Annex 14, and Annex 15, to the mandatory monitored areas related to the aeronautical infrastructure;
A three-dimensional Surface obtained by merging both digital surface models (DSMs), the previous and the new one, and stereoscopic images, Panchromatic Remote-Sensing Instrument for Stereo Mapping-Advanced Land Observing Satellite (PRISM-ALOS) or SPOT-5 (multi-pass), if necessary.

7. Method to generate Airport Obstruction Charts according to claim 1, characterized by, the accuracy of the results in terms of vertical accuracy to be fixed between 10 and 3 meters.
